(19) United States
(12) Patent Application Publication
(10) Pub. No.: US 2025/0190859 A1
(43) Pub. Date: Jun. 12, 2025

(54) LEARNING DEVICE, SQUEAL NOISE PREDICTION DEVICE, LEARNING METHOD, AND SQUEAL NOISE PREDICTION METHOD

(71) Applicants: Hyundai Motor Company, Seoul (KR); Kia Corporation, Seoul (KR)

(72) Inventors: Sung Hyun Cho, Yongin-si (KR); Sung Ho Kim, Seoul (KR); Jung Ro Yoon, Seongnam-si (KR); Jeong Kyu Kim, Suwon-si (KR); Yoon Cheol Kim, Suwon-si (KR); Kyung Rok Choi, Suwon-si (KR)

(21) Appl. No.: 18/627,743

(22) Filed: Apr. 5, 2024

(30) Foreign Application Priority Data
Dec. 12, 2023 (KR) 10-2023-0180172

(51) Int. Cl. G06N 20/00; B60T 8/171; B60T 8/172; B60T 8/174; H04R 3/00

(52) U.S. Cl. CPC G06N 20/00; B60T 8/171; B60T 8/172; B60T 8/174; H04R 3/005; B60T 2210/30; B60T 2250/00; B60T 2270/60; H04R 2499/13

(57) ABSTRACT

A learning device can include one or more processors, and a storage medium storing computer-readable instructions that, when executed by the one or more processors, enable the one or more processors to identify one of or both of first noise data measured from a first external device provided in a vehicle and second noise data measured from a second external device of a user that drives the vehicle, and apply training data for online learning, the training data including the one of or both of the first noise data and the second noise data, to a squeal noise prediction model trained to predict squeal noise of the vehicle to perform online learning of the squeal noise prediction model.

### CROSS-REFERENCE TO RELATED APPLICATIONS

This application claims the benefit of priority to Korean Patent Application No. 10-2023-0180172, filed in the Korean Intellectual Property Office on Dec. 12, 2023, the entire contents of which are incorporated herein by reference.

### TECHNICAL FIELD

The present disclosure relates to a learning device for predicting squeal noise in a vehicle.

### BACKGROUND

A braking device of a vehicle is a device that converts rotational kinetic energy of the wheel of the vehicle into thermal energy through friction between a disk and a pad included in the braking device. Therefore, when resonance occurs in the braking device due to exciting energy between the disk and the pad and when the resonance is greater than the damping limit of the system, noise may be generated.

Herein, when the noise corresponds to the frequency range of 1 KHz to 16 KHz, it is squeal noise. This causes great dissatisfaction of users as the sound is unpleasant. However, although the vehicle is designed to prevent squeal noise of the braking device in the stage of developing the vehicle, because wear occurs on the disk and the pad included in the braking device over time and the vibration characteristic of the braking device also changes, noise that is not generated in the stage of developing the vehicle may be generated.

To address such a problem, there is a need to develop a technology for predicting squeal noise and a technology for reducing the predicted squeal noise.

### SUMMARY

The present disclosure relates to a learning device, a squeal noise prediction device, a learning method, and a squeal noise prediction method, and more particularly, relates to technologies for predicting squeal noise.

Some embodiments of the present disclosure can solve the above-mentioned problems occurring in the prior art while advantages achieved by the prior art are maintained intact.

An embodiment of the present disclosure can provide a learning device for identifying first noise data measured from a first external device provided in a vehicle or second noise data measured from a second external device of a user who drives the vehicle, or any combination thereof, to reflect a relation between a rapid change in friction coefficient between a disk and a pad and a torque estimate in a squeal noise prediction model, a squeal noise prediction device, a learning method, and a squeal noise prediction method.

An embodiment of the present disclosure can provide a learning device for training a squeal noise prediction model based on a first loss function associated with regression or a second loss function associated with classification to increase the satisfaction of a user by use of a squeal noise prediction model with better performance than training the squeal noise prediction model using one loss function, a squeal noise prediction device, a learning method, and a squeal noise prediction method.

An embodiment of the present disclosure can provide a learning device for performing online learning of a squeal noise prediction model using the obtained data after training the squeal noise prediction model to reduce squeal noise capable of being generated from a braking device that is aging according to a usage condition of a user, a squeal noise prediction device, a learning method, and a squeal noise prediction method.

Technical problems to be solved by some embodiments of the present disclosure are not necessarily limited to the aforementioned problems, and solutions provided by an embodiment to other technical problems not mentioned herein can be clearly understood from the following description by those skilled in the art to which the present disclosure pertains.

According to an embodiment of the present disclosure, a learning device may include a memory storing computer-executable instructions and at least one processor that accesses the memory and executes the instructions. The at least one processor may identify at least one of first noise data measured from a first external device provided in a vehicle or second noise data measured from a second external device of a user that drives the vehicle, or any combination thereof, and may apply training data for online learning, the training data including the at least one of the first noise data or the second noise data, or the any combination thereof, to a squeal noise prediction model trained to predict squeal noise of the vehicle to perform online learning of the squeal noise prediction model.

In an embodiment, the at least one processor may output a request for inputting whether the squeal noise is generated to the user, at a target time point when a braking device of the vehicle operates, may identify third noise data about determination of the user, based on receiving a response about whether the squeal noise is generated from the user, and may include the third noise data in the training data for online learning.

In an embodiment, the at least one processor may delete training data different from the training data for online learning and applied to training of the trained squeal noise prediction model, from the vehicle, based on identifying the at least one of the first noise data or the second noise, or the any combination thereof.

In an embodiment, the at least one processor may divide the training data for online learning into a mini-batch being at least one group and apply the mini-batch to the squeal noise prediction model in a predetermined order to perform the online learning of the squeal noise prediction model.

In an embodiment, the at least one processor may determine whether the squeal noise is generated in the braking device, based on the first noise data, the second noise data, and the third noise data, and may perform the online learning of the squeal noise prediction model, based on the mini-batch, based on that the squeal noise is generated in the braking device.

In an embodiment, the at least one processor may apply the mini-batch and target data corresponding to the mini-batch to the squeal noise prediction model to obtain temporary output data and may perform the online learning of the squeal noise prediction model, based on a first loss value obtained by applying the temporary output data and the target data to a first loss function associated with regression.

In an embodiment, the at least one processor may perform the online learning of the squeal noise prediction model, based on a second loss value obtained by applying the temporary output data and the target data to a second loss function associated with classification.

In an embodiment, the first external device may include a hands-free microphone of the vehicle, and the second external device may include a microphone of a portable device of the user.

According to an embodiment of the present disclosure, a squeal noise prediction device may include a memory storing computer-executable instructions and at least one processor that accesses the memory and executes the instructions. The at least one processor may apply at least one of data extracted from a braking device of a vehicle, data corresponding to a wheel of the vehicle, data measured from an external sensor of the vehicle, data measured from a hands-free microphone of the vehicle, or data measured from a portable device of a user of the vehicle, or any combination thereof to a squeal noise prediction model to obtain an expected probability indicating a probability that squeal noise will be generated in the braking device, determine that the squeal noise is generated in the braking device, based on that the expected probability is greater than a predetermined threshold, and may determine an oil pressure control mode of the vehicle, based on at least one of a stability control mode of the vehicle, an outside air temperature measured from the external sensor, or a driving time of the vehicle, or any combination thereof, based on that the squeal noise is generated in the braking device.

In an embodiment, the at least one processor may determine a torque compensating amount corresponding to the determined oil pressure control mode, based on an oil pressure decrease amount corresponding to the determined oil pressure control mode, a friction coefficient between a disk and a pad included in the braking device, and a piston area of the disk included in the braking device, and may apply the torque compensating amount to at least one of a motor for generating a braking force through regenerative braking in the vehicle, a motor for generating a braking force by use of an electronic parking brake of the vehicle, or a transmission for generating a braking force by use of an engine brake of the vehicle in the vehicle, or any combination thereof to generate a braking force lost by the oil pressure decrease amount to brake the vehicle.

According to an embodiment of the present disclosure, a learning method may include identifying at least one of first noise data measured from a first external device provided in a vehicle or second noise data measured from a second external device of a user that drives the vehicle, or any combination thereof and applying training data for online learning, the training data including the at least one of the first noise data or the second noise data, or the any combination thereof, to a squeal noise prediction model trained to predict squeal noise of the vehicle to perform online learning of the squeal noise prediction model.

In an embodiment, the performing of the online learning of the squeal noise prediction model may include outputting a request for inputting whether the squeal noise is generated to the user, at a target time point when a braking device of the vehicle operates, identifying third noise data about determination of the user, based on receiving a response about whether the squeal noise is generated from the user, and including the third noise data in the training data for online learning.

In an embodiment, the performing of the online learning of the squeal noise prediction model may include deleting training data different from the training data for online learning and applied to training of the trained squeal noise prediction model, from the vehicle, based on identifying the at least one of the first noise data or the second noise, or the any combination thereof.

In an embodiment, the performing of the online learning of the squeal noise prediction model may include dividing the training data for online learning into a mini-batch being at least one group and applying the mini-batch to the squeal noise prediction model in a predetermined order to perform the online learning of the squeal noise prediction model.

In an embodiment, the performing of the online learning of the squeal noise prediction model may include determining whether the squeal noise is generated in the braking device, based on the first noise data, the second noise data, and the third noise data, and performing the online learning of the squeal noise prediction model, based on the mini-batch, based on that the squeal noise is generated in the braking device.

In an embodiment, the performing of the online learning of the squeal noise prediction model may include applying the mini-batch and target data corresponding to the mini-batch to the squeal noise prediction model to obtain temporary output data and performing the online learning of the squeal noise prediction model, based on a first loss value obtained by applying the temporary output data and the target data to a first loss function associated with regression.

In an embodiment, the learning method may further include performing the online learning of the squeal noise prediction model, based on a second loss value obtained by applying the temporary output data and the target data to a second loss function associated with classification.

According to an embodiment of the present disclosure, a squeal noise prediction method may include applying at least one of data extracted from a braking device of a vehicle, data corresponding to a wheel of the vehicle, data measured from an external sensor of the vehicle, data measured from a hands-free microphone of the vehicle, or data measured from a portable device of a user of the vehicle, or any combination thereof to a squeal noise prediction model to obtain an expected probability indicating a probability that squeal noise will be generated in the braking device, determining that the squeal noise is generated in the braking device, based on that the expected probability is greater than a predetermined threshold, and determining an oil pressure control mode of the vehicle, based on at least one of a stability control mode of the vehicle, an outside air temperature measured from the external sensor, or a driving time of the vehicle, or any combination thereof, based on that the squeal noise is generated in the braking device.

In an embodiment, the squeal noise prediction method may further include determining a torque compensating amount corresponding to the determined oil pressure control mode, based on an oil pressure decrease amount corresponding to the determined oil pressure control mode, a friction coefficient between a disk and a pad included in the braking device, and a piston area of the disk included in the braking device, and applying the torque compensating amount to at least one of a motor for generating a braking force through regenerative braking in the vehicle, a motor for generating a braking force by use of an electronic parking brake of the vehicle, or a transmission for generating a braking force by use of an engine brake of the vehicle in the vehicle, or any combination thereof to generate a braking force lost by the oil pressure decrease amount to brake the vehicle.

### BRIEF DESCRIPTION OF THE DRAWINGS

The above and other features and advantages of the present disclosure can be more apparent from the following detailed description taken in conjunction with the accompanying drawings, in which:

FIG. 1 is a drawing illustrating a learning device for performing online learning of a squeal noise prediction model according to an embodiment of the present disclosure;

FIG. 2 is a flowchart for describing an online learning method of a squeal noise prediction model according to an embodiment of the present disclosure;

FIG. 3 is a drawing illustrating a method for obtaining pieces of data for training a squeal noise prediction model, in a learning device according to an embodiment of the present disclosure;

FIG. 4 is a flowchart for describing a method for predicting squeal noise by use of a trained squeal noise prediction model, in a squeal noise prediction device according to an embodiment of the present disclosure;

FIG. 5 is a flowchart for describing online learning of a squeal noise prediction model according to an embodiment of the present disclosure;

FIG. 6 is a flowchart for describing a method for determining an oil pressure control mode, in a squeal noise prediction device according to an embodiment of the present disclosure;

FIG. 7 is a flowchart for describing a method for braking a vehicle, in a squeal noise prediction device according to an embodiment of the present disclosure; and

FIG. 8 is a drawing illustrating a computing system associated with a learning device, a squeal noise prediction device, a learning method, and a squeal noise prediction method according to an embodiment of the present disclosure.

With regard to description of drawings, same or similar denotations may be used for same or similar components.

### DETAILED DESCRIPTION OF ILLUSTRATIVE EMBODIMENTS

Hereinafter, some example embodiments of the present disclosure will be described in detail with reference to the drawings. In adding reference numerals to the components of each drawing, it can be noted that an identical component can designated by an identical numeral even when displayed on other drawings. In addition, a detailed description of well-known features or functions can be omitted to not unnecessarily obscure the gist of the present disclosure. Hereinafter, various example embodiments of the present disclosure may be described with reference to the accompanying drawings. However, it can be understood that the example embodiments are not intended to necessarily limit the present disclosure to specific implementation forms and an embodiment can include various modifications, equivalents, and/or alternatives of other embodiments of the present disclosure. With regard to the description of drawings, similar components may be marked by similar reference numerals.

In the present disclosure, the terms “first”, “second”, “A”, “B”, “(a)”, “(b)”, and the like, may be used herein. Such terms can be only used to distinguish one component from another component, but do not necessarily limit the corresponding components irrespective of the order or priority of the corresponding components. Furthermore, unless otherwise defined, terms including technical and scientific terms used herein can have a same meaning as being generally understood by those skilled in the art to which the present disclosure pertains. Such terms as those defined in a generally used dictionary can be interpreted as having meanings equal to the contextual meanings in the relevant field of art. For example, the terms, such as “first”, “second”, “1st”, “2nd”, or the like, used in the present disclosure may be used to refer to various components regardless of the order and/or the priority and to distinguish one component from another component, but do not necessarily limit the components. For example, a first user device and a second user device indicate different user devices, irrespective of the order and/or priority. For example, without departing the scope of the present disclosure, a first component may be referred to as a second component, and similarly, a second component may be referred to as a first component.

In the present disclosure, the expressions “have”, “may have”, “include” and “comprise”, or “may include” and “may comprise” indicate existence of corresponding features (e.g., components such as numeric values, functions, operations, or parts), but do not exclude presence of additional features.

It can be understood that when a component (e.g., a component) is referred to as being “(operatively or communicatively) coupled with/to” or “connected to” another component (e.g., a second component), it can be directly coupled with/to or connected to the other component or an intervening component (e.g., a third component) may be present. In contrast, when a component (e.g., a first component) is referred to as being “directly coupled with/to” or “directly connected to” another component (e.g., a second component), it can be understood that there is no intervening component (e.g., a third component).

According to the situation, the expression “configured to” used in the present disclosure may be used interchangeably with, for example, the expression “suitable for”, “having the capacity to”, “designed to”, “adapted to”, “made to”, or “capable of”.

The term “configured to” must not mean only “specifically designed to” in hardware. Instead, the expression “a device configured to” can mean that the device is “capable of” operating together with another device or other parts. For example, a “processor configured to perform A, B, and C” may mean a generic-purpose processor (e.g., a central processing unit (CPU) or an application processor) that may perform corresponding operations by executing one or more software programs that store a dedicated processor (e.g., an embedded processor) for performing a corresponding operation or a memory device. The terms of a singular form may include plural forms unless the context clearly indicates otherwise. All the terms used herein, which include technical or scientific terms, may have the same meaning that is generally understood by a person skilled in the art described in the present disclosure. It will be further understood that terms, which are defined in a dictionary and commonly used, should also be interpreted as is customary in the relevant related art and not in an idealized or overly formal detect unless expressly so defined herein in various embodiments of the present disclosure. In some cases, even though terms are terms which are defined in the specification, they may not be interpreted to exclude embodiments of the present disclosure.

In the present disclosure, the expressions “A or B”, “at least one of A or/and B”, or “one or more of A or/and B”, and the like, may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, in describing an embodiment of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. Particularly, the phrase such as “at least one of A, B, or C, or any combination thereof” may include “A”, “B”, or “C”, or “AB” or “ABC”, which is a combination thereof.

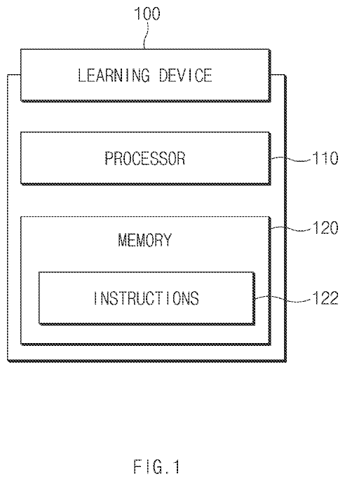

Hereinafter, some example embodiments of the present disclosure will be described in detail with reference to FIGS. 1 to 8.

FIG. 1 is a drawing illustrating a learning device for performing online learning of a squeal noise prediction model according to an embodiment of the present disclosure.

A learning device 100 according to an embodiment may include a processor 110 and a memory 120 including instructions 122, either or both of which may be in plural or may include plural components thereof.

The learning device 100 may indicate a device that performs online learning of a pre-trained squeal noise prediction model. For example, the learning device 100 may perform the following operations to train the squeal noise prediction model. The learning device 100 may identify at least one of first noise data measured from a first external device provided in a vehicle or second noise data measured from a second external device of a user that drives the vehicle, or any combination thereof. The learning device 100 may apply training data for online learning, which includes at least one of the first noise data or the second noise data, or any combination thereof, to the squeal noise prediction model trained to predict squeal noise of the vehicle to perform online learning of the squeal noise prediction model. For example, the first external device may include a hands-free microphone of the vehicle. The first noise data may include noise measured from the hands-free microphone of the vehicle. The second external device may include a microphone of a portable device of the user. The second noise data may include noise measured from the portable device.

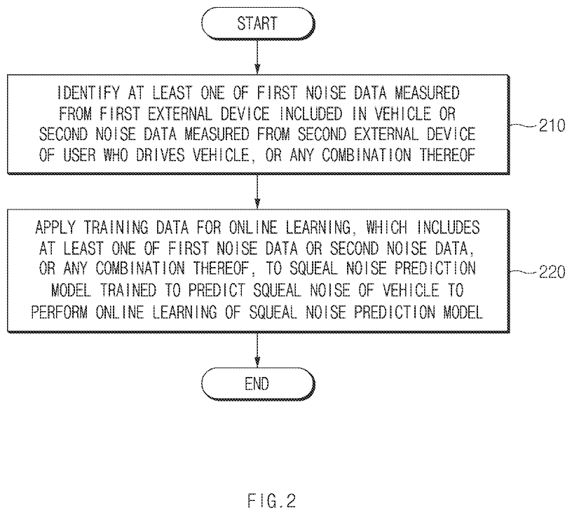

The learning device 100 may output a request for inputting whether squeal noise is generated to the user, at a target time point when a braking device of the vehicle operates. As a result, the learning device 100 may identify third noise data about determination of the user, based on receiving a response about whether the squeal noise is generated from the user. The learning device 100 may include the third noise data in the training data for online learning. The learning device 100 may apply training data for online learning, which includes at least one of the first noise data, the second noise data, or the third noise data, or any combination thereof, to the squeal noise prediction model trained to predict the squeal noise of the vehicle to perform the online learning of the squeal noise prediction model. A detailed description associated with the online learning will be given below with reference to FIG. 2.

The processor 110 may execute software and may control at least one other component (e.g., a hardware or software component) connected with the processor 110. In addition, the processor 110 may perform a variety of data processing or calculation. For example, the processor 110 may store the first noise data, the second noise data, the third noise data, and the like in the memory 120. For reference, the processor 110 may perform all operations performed by the learning device 100. Therefore, for convenience of description in the specification, the operation performed by the learning device 100 is mainly described as an operation performed by the processor 110.

Furthermore, for convenience of description in the specification, the processor 110 is mainly described as, but not limited to, one processor. For example, the learning device 100 may include at least one processor. Each of the at least one processor may perform all operations associated with training the squeal noise prediction model.

The memory 120 may temporarily and/or permanently store various pieces of data and/or information required to train the squeal noise prediction model. For example, the memory 120 may store the first noise data, the second noise data, the third noise data, and the like.

FIG. 2 is a flowchart for describing an online learning method of a squeal noise prediction model according to an embodiment of the present disclosure.

In operation 210, a learning device (e.g., a learning device 100 of FIG. 1) according to an embodiment may identify at least one of first noise data measured from a first external device provided in a vehicle or second noise data measured from a second external device of a user who drives the vehicle, or any combination thereof.

The learning device may delete training data, which is different from training data for online learning and is applied to training of the trained squeal noise prediction model, from the vehicle, based on identifying the at least one of the first noise data or the second noise, or the any combination thereof. For example, the training data applied to the training of the trained squeal noise prediction model (hereinafter referred to as “training data”) may be different from the training data for online learning. In detail, the training data may indicate data generated before the squeal noise prediction model is trained. Otherwise, the training data for online learning may indicate data generated to perform online learning of the trained squeal noise prediction model, after the squeal noise prediction model is trained.

In operation 220, the learning device may apply training data for online learning, which includes the at least one of the first noise data or the second noise data, or the any combination thereof, to the squeal noise prediction model trained to predict squeal noise of the vehicle to perform online learning of the squeal noise prediction model. For example, the squeal noise prediction model may indicate a model that is trained and/or being trained by use of machine learning and may be a trained machine learning model that outputs a training output (e.g., a squeal noise prediction probability) from a training input (e.g., the training data for online learning).

For example, the squeal noise prediction model may include a neural network. The neural network may include a plurality of layers. Each layer may include a plurality of nodes. The node may have a node value determined based on an activation function. A node of any layer may be connected with a node (e.g., another node) of another layer through a link (e.g., a connection edge) with a connection weight. The node value of the node may be propagated to other nodes through the link. In an inference operation of the neural network, node values may be forward propagated in the direction of a next layer from a previous layer.

Illustratively, the forward propagation calculation in the squeal noise prediction model may indicate calculation of propagating a node value based on input data, in the direction facing the output layer from the input layer of the squeal noise prediction model. In other words, a node value of the node may be propagated (e.g., forward propagated) to a node (e.g., a next node) of a next layer connected with the node through the connection edge. For example, the node may receive a value weighted by the connection weight from a previous node (e.g., a plurality of nodes) connected through the connection edge.

The node value of the node may be determined based on applying an activation function to the sum (e.g., weighted sum) of weighted values received from previous nodes. The parameter of the neural network may illustratively include the above-mentioned connection weight. The parameter of the neural network may be updated to be changed in a direction in that a value of a loss function is targeted (e.g., a direction where a loss is minimized).

The machine learning model (e.g. the trained squeal noise prediction model) may be generated by use of machine learning. A learning algorithm may include, for example, but is not limited to, supervised learning, unsupervised learning, semi-supervised learning, or reinforcement learning.

The learning algorithm may include a machine learning system including an algorithm for performing training from data. Such an algorithm may include a function for operating a computer without artificial intelligence (AI) or a program from the outside, which is automatically learned by the computer without automatic reasoning, automatic adaptation, automatic determination, automatic learning, or an external program or the artificial intelligence (AI), or any combination thereof, for example. The machine learning may include classification, regression analysis, feature learning, online learning, autonomous learning, supervised learning, cluster analysis, dimension reduction, structure prediction, abnormal behavior detection, or a neural network, or any combination thereof, for example.

The machine learning model may include a plurality of artificial neural network layers. In detail, the trained squeal noise prediction model may include a shared layer including at least one convolution operation and a plurality of classifier layers connected with the shared layer. An artificial neural network may be, but is not limited to, a combination of at least one of a deep neural network (DNN), a convolutional neural network (CNN), a U-net for image segmentation (U-net), a recurrent neural network (RNN), a restricted Boltzmann machine (RBM), a deep belief network (DBN), a bidirectional recurrent deep neural network (BRDNN), or deep Q-networks, or any combination thereof, for example. For example, the trained squeal noise prediction model may be a mixed effect reflection machine learning model. Herein, the mixed effect reflection machine learning model may include a regression methodology for outputting a squeal noise prediction probability from input data and may include a methodology considering a distribution-based random effect. Illustratively, the mixed effect reflection machine learning model may include linear regression, logistic regression, a classification and regression tree algorithm, a support vector machine (SVM), Naive Bayes, K-nearest neighbor, a random forest algorithm, XGBoost, LightGBM, mixed effects random forests (MERF), mixed effects light gradient boosting (MELGB), or the like, for example.

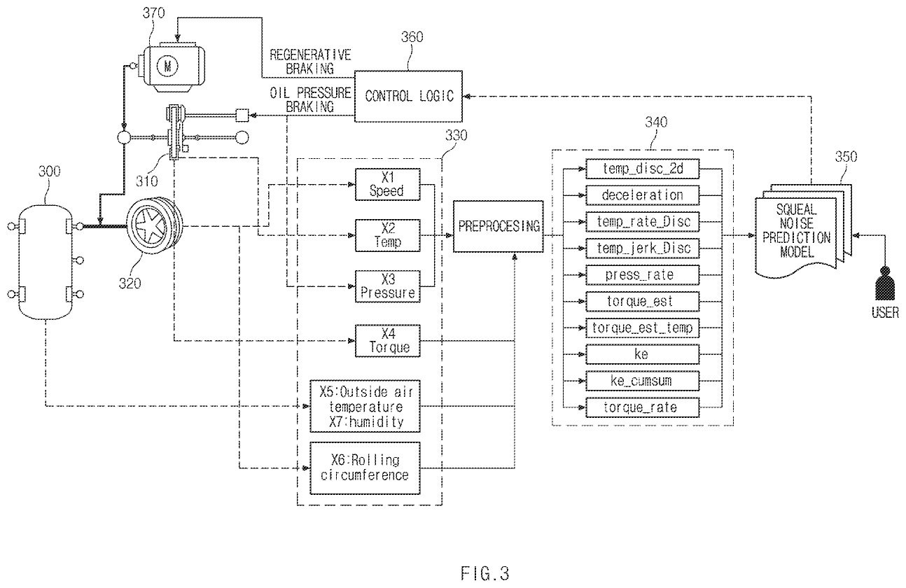

FIG. 3 is a drawing illustrating a method for obtaining pieces of data for training a squeal noise prediction model, in a learning device according to an embodiment of the present disclosure.

Referring to FIG. 3, FIG. 3 illustrates a method for training a squeal noise prediction model 350. In detail, the squeal noise prediction model 350 may be trained by a learning device (e.g., a learning device 100 of FIG. 1). In addition, online learning of the squeal noise prediction model 350 may be performed by the learning device. Hereinafter, a description will be given in detail of the example method for training the squeal noise prediction model 350.

The learning device according to an embodiment may preprocess a raw dataset 330 received from a braking device 310 of a vehicle 300, a wheel 320 of the vehicle 300, and an external sensor of the vehicle 300 to obtain training input data 340, at a target time point when the braking device 310 operates.

The learning device may generate first raw data including at least one of oil pressure data (e.g., shown as “X3 Pressure” in FIG. 3) associated with oil pressure applied to the braking device 310, disk temperature data (e.g., shown as “X2 Temp” in FIG. 3), or torque data (e.g., shown as “X4 Torque” in FIG. 3) associated with a torque applied to a disk included in the braking device 310, or any combination thereof.

The learning device may generate second raw data, including at least one of wheel speed data (e.g., shown as “X1 Speed” in FIG. 3) associated with a speed of the wheel 320 or rolling circumference data (e.g., shown as “X6 rolling circumference” in FIG. 3) of a tire combined with the wheel 320, or any combination thereof, at the target time point.

The learning device may generate third raw data, including at least one of outside air temperature data (e.g., shown as “X5 outside air temperature” in FIG. 3) from an external sensor of the vehicle 300 or humidity data (e.g., shown as “X7 humidity” in FIG. 3) from the external sensor of the vehicle 300, or any combination thereof, at the target time point.

The learning device may preprocess the raw dataset 330 including the first raw data, the second raw data, and the third raw data to obtain the training input data 340. For example, the learning device may bind a plurality of pieces of sub-input data generated by preprocessing the raw dataset 330 to obtain the training input data 340.

The learning device may generate first sub-input data including the square of the disk temperature data (i.e., the process of preprocessing the disk temperature data, same as below) and the square of the wheel speed data.

The learning device may generate second sub-input data including a change between the wheel speed data and wheel speed data at a subsequent time point subsequent to the target time point, a change between the disk temperature data and disk temperature data at the subsequent time point, a change between the oil pressure data and oil pressure data at the subsequent time point, and a change between the torque data and torque data at the subsequent time point.

The learning device may generate third sub-input data including first torque estimation data generated based on the change between the wheel speed data and the wheel speed data at the subsequent time point subsequent to the target time point and second torque estimation data generated based on the first torque estimation data and the disk temperature data.

The learning device may bind the first sub-input data, the second sub-input data, and the third sub-input data to obtain the training input data 340. However, the method for obtaining the training input data 340 is not limited thereto. For example, the learning device may obtain the training input data 340 through preprocessing of torque wheel raw data (not shown) obtained based on at least one of a torque applied to the braking device 310, a torque applied to the wheel 320, or a torque applied to or by a motor 370, or any combination thereof.

In detail, the learning device may bind the first sub-input data, the second sub-input data, and the third sub-input data to obtain first training input data (not shown). The learning device may obtain second training input data (not shown) through preprocessing of the torque wheel raw data. The learning device may apply the first training input data to the squeal noise prediction model 350 to perform training the squeal noise prediction model 350. The learning device may apply the second training input data to the squeal noise prediction model 350 to train the squeal noise prediction model 350, based on that a time for the above-mentioned training is greater than a predetermined training time.

The learning device may train the squeal noise prediction model 350 using the first training input data to reflect a relation between pieces of data obtained from the vehicle 300 and squeal noise in the squeal noise prediction model 350. Thereafter, the learning device may train the squeal noise prediction model 350 using the first training input data to reflect a relation between pieces of torque data obtained from the vehicle 300 and squeal noise in the squeal noise prediction model 350.

The learning device may apply the obtained training input data 340 and target data corresponding to squeal noise generated by the training input data 340 to the squeal noise prediction model 350. The learning device may apply temporary output data obtained from the squeal noise prediction model 350 and the target data to a loss function to train the squeal noise prediction model 350.

The learning device may use a first loss function or a second loss function to train the squeal noise prediction model 350. For example, the first loss function may be a loss function associated with regression, which may include a mean absolute error (MAE), a mean squared error (MSE), a root mean square error (RMS), or the like. The second loss function may be a loss function associated with classification, which may include binary cross-entropy, categorical cross-entropy, or the like, for example. The learning device may use at least one of the first loss function or the second loss function to train the squeal noise prediction model 350, based on a condition predetermined by a user.

In detail, when the second loss function is used to train the squeal noise prediction model 350, the learning device may determine a classification class of the training input data 340, based on a comparison between the temporary output data and a predetermined threshold. The learning device may train the squeal noise prediction model 350, based on a loss value obtained by applying the classification class and the target data to the second loss function.

The classification class of the training input data 340 may be determined by Table 1 below.

TABLE 1

| Classification class | Contents |
|---|---|
| 0 | Determine that noise is not generated, |
| | Predict noise of 25% or less of noise generation |
| | determination dB |
| 1 | Determine that noise is not generated, |
| | Predict noise of 50% or less of noise generation |
| | determination dB |
| 2 | Determine that noise is not generated, |
| | Predict noise of 75% or less of noise generation |
| | determination dB |
| 3 | Determine that noise is generated, |
| | Predict noise of 125% or less of noise generation |
| | determination dB |
| 4 | Determine that noise is generated, |
| | Predict noise of 150% or less of noise generation |
| | determination dB |

Herein, that the classification class is “0” may be that the training input data 340 has a class in which squeal noise is not generated, which may mean that noise of 25% or less of squeal noise generation determination dB is predicted. That the classification class is “1” may be that the training input data 340 has the class in which the squeal noise is not generated, which may mean that noise of 50% or less of the squeal noise generation determination dB is predicted. That the classification class is “2” may be that the training input data 340 has the class in which the squeal noise is not generated, which may mean that noise of 75% or less of the squeal noise generation determination dB is predicted. That the classification class is “3” may be that the training input data 340 has a class in which the squeal noise is generated, which may mean that noise of 125% or less of the squeal noise generation determination dB is predicted. That the classification class is “4” may be that the training input data 340 has the class in which the squeal noise is generated, which may mean that noise of 150% or less of the squeal noise generation determination dB is predicted.

The learning device may apply the result output from the squeal noise prediction model 350 trained by at least one of the first loss function or the second loss function (e.g., an expected probability of squeal noise or whether squeal noise is generated) to control logic 360. The learning device may apply the output result to the control logic 360, thus adjusting and/or correcting oil pressure braking in the braking device 310 or adjusting and/or correcting regenerative braking in a regenerative braking motor.

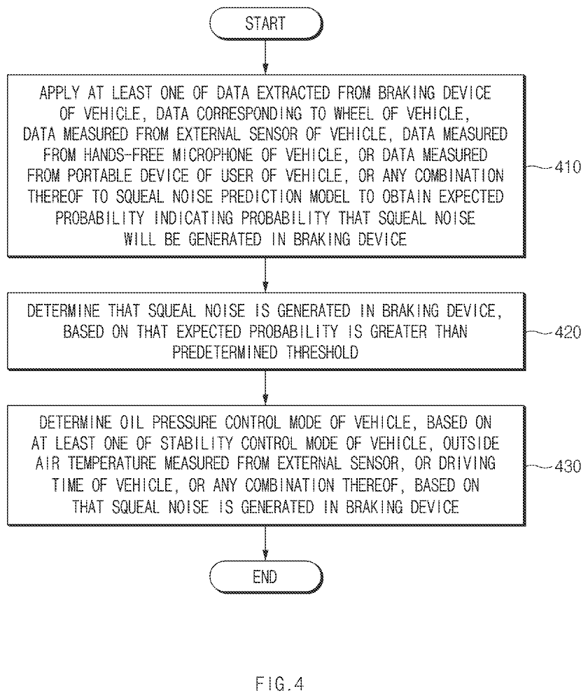

FIG. 4 is a flowchart for describing a method for predicting squeal noise by use of a trained squeal noise prediction model, in a squeal noise prediction device according to an embodiment of the present disclosure.

In operation 410, the squeal noise prediction device according to an embodiment may apply at least one of data extracted from a braking device of a vehicle, data corresponding to a wheel of the vehicle, data measured from an external sensor of the vehicle, data measured from a hands-free microphone of the vehicle, or data measured from a portable device of a user of the vehicle, or any combination thereof to a squeal noise prediction model to obtain an expected probability indicating a probability that squeal noise will be generated in the braking device.

For example, the squeal noise prediction device may include a processor and a memory including instructions. The processor may execute software and may control at least one other component (e.g., a hardware or software component) connected with the processor. In addition, the processor may perform a variety of data processing or calculation. For example, the processor may store the data corresponding to the wheel, the data measured from the external sensor of the vehicle, the data measured from the hands-free microphone of the vehicle, the data measured from the portable device of the user of the vehicle, and the trained squeal noise prediction model in the memory. The memory may temporarily and/or permanently store various pieces of data and/or information required to infer the trained squeal noise prediction model.

In operation 420, the squeal noise prediction device may determine that the squeal noise is generated in the braking device, based on that the expected probability is greater than a predetermined threshold. For example, when the expected probability obtained from the trained squeal noise prediction model is greater than the threshold predetermined by a user, the squeal noise prediction device may determine that the squeal noise is generated in the braking device.

In operation 430, the squeal noise prediction device may determine an oil pressure control mode of the vehicle, based on at least one of a stability control mode of the vehicle, an outside air temperature measured from the external sensor, or a driving time of the vehicle, or any combination thereof, based on that the squeal noise is generated in the braking device. For example, the oil pressure control mode may be a mode in which the amount of oil pressure applicable to the braking device is determined.

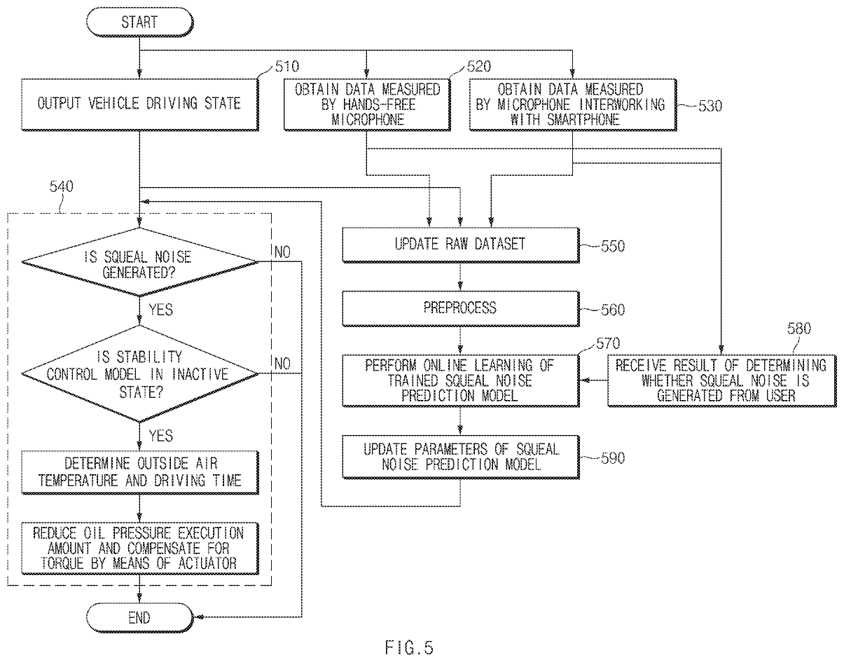

FIG. 5 is a flowchart for describing online learning of a squeal noise prediction model according to an embodiment of the present disclosure.

In operation 210, a learning device (e.g., a learning device 100 of FIG. 1) according to an embodiment may perform online learning of a trained squeal noise prediction model. For example, in operations 510 to 530, the squeal noise prediction device according to an embodiment may output a vehicle driving state, may obtain data measured by a hands-free microphone of a vehicle, and may obtain data measured by a microphone interworking with a smartphone. The squeal noise prediction device may transmit the obtained data measured by the hands-free microphone and the obtained data measured by the microphone interworking with the smartphone to a learning device. As a result, in operation 540, the squeal noise prediction device may perform the operations described with reference to FIG. 4.

The learning device may perform online learning of the trained squeal noise prediction model, based on the pieces of data obtained in operations 520 and 530. For example, in operation 550, the learning device may update a raw dataset (e.g., a raw dataset 330 of FIG. 3). Illustratively, the learning device may replace the raw dataset with the pieces of data obtained in operations 520 and 530 to update the raw dataset.

The learning device may determine whether squeal noise is generated in a braking device of the vehicle, based on first noise data measured from a first external device (e.g., the hands-free microphone of the vehicle) and second noise data measured from a second external device (e.g., a portable device) of a user who drives the vehicle.

The learning device may apply at least one of the first noise data, the second noise data, or third noise data to the trained squeal noise prediction model to determine whether squeal noise is generated in the braking device. The learning device may perform online learning of the squeal noise prediction model, based on a mini-batch, based on that the squeal noise is generated in the braking device.

When squeal noise is simultaneously measured and/or obtained from a left braking device and a right braking device with respect to the direction of progress of the vehicle, the learning device may determine the number of times the squeal noise is generated as two times. The learning device may determine whether squeal noise is generated, through a comparison between noise generated in the braking device and a predetermined frequency. The learning device may determine the noise generated in the braking device as squeal noise, based on a criterion determined by the user.

In operation 560, the learning device may preprocess the raw dataset to obtain training input data for online learning. For reference, the online learning described in the specification may indicate applying pieces of data in a small group, which is referred to as the mini-batch, to a trained machine learning model to additionally train the trained machine learning model.

In operation 570, the learning device may perform online learning of the trained squeal noise prediction model. For example, the learning device may divide training input data (e.g., the training input data for online learning) obtained at a time point different from a target time point into the mini-batch that is at least one group and may apply the mini-batch to the trained squeal noise prediction model in a predetermined order, thus performing the online learning of the squeal noise prediction model.

The learning device may apply the mini-batch and target data corresponding to the mini-batch to the squeal noise prediction model to obtain temporary output data. The learning device may perform the online learning of the squeal noise prediction model, based on a first loss value obtained by applying the temporary output data and the target data to a first loss function associated with regression. However, the method for performing the online learning of the squeal noise prediction model is not limited thereto. For example, the learning device may perform the online learning of the squeal noise prediction model, based on a second loss value obtained by applying the temporary output data and the target data to a second loss function associated with classification.

In operation 580, the learning device may receive the result of determining whether the squeal noise is generated from the user. For example, whenever the squeal noise is generated in the braking device, the user may transmit the squeal noise generation result to the learning device. The learning device may perform the online learning of the squeal noise prediction model, based on the result received from the user. In other words, even when determining that the squeal noise is not generated in the braking device by applying at least one of the first noise data or the second noise data to the trained squeal noise prediction model, the learning device may perform the online learning of the squeal noise prediction model depending on the request of the user.

In operation 590, the squeal noise prediction device may update parameters of the squeal noise prediction model. In other words, as the learning device performs the online learning of the squeal noise prediction model, the squeal noise prediction device may update the parameters of the squeal noise prediction model trained by the learning device.

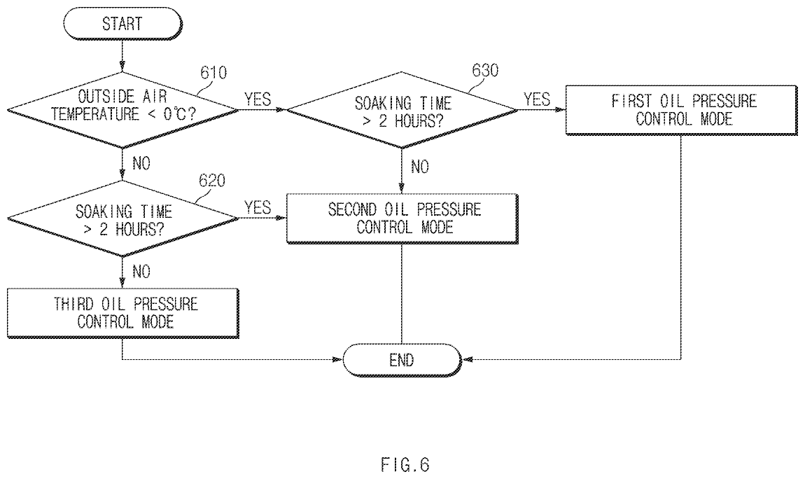

FIG. 6 is a flowchart for describing a method for determining an oil pressure control mode, in a squeal noise prediction device according to an embodiment of the present disclosure.

The squeal noise prediction device according to an embodiment may determine an oil pressure control mode of a braking device, based on a first sub-condition for comparing an outside air temperature with a first threshold and a second sub-condition for comparing a driving time with a second threshold, based on that a stability control mode is deactivated.

In operation 610, the squeal noise prediction device may compare the outside air temperature with the first threshold (e.g., shown as 0 degrees Celsius in FIG. 6). For example, when the outside air temperature is greater than or equal to the first threshold, in operation 620, the squeal noise prediction device may compare a driving time (e.g., shown as soaking time in FIG. 6) of a vehicle with the second threshold (e.g., shown as 2 hours in FIG. 6). When the outside air temperature is greater than or equal to the first threshold and the driving time of the vehicle is less than or equal to the second threshold, the squeal noise prediction device may determine the oil pressure control mode of the braking device as a third oil pressure control mode.

When the outside air temperature is less than the first threshold, in operation 630, the squeal noise prediction device may compare the driving time of the vehicle with the second threshold. When the outside air temperature is less than the first threshold and the driving time of the vehicle is greater than the second threshold, the squeal noise prediction device may determine the oil pressure control mode of the braking device as a first oil pressure control mode. Otherwise, when the outside air temperature is less than the first threshold and the driving time of the vehicle is less than or equal to the second threshold, the squeal noise prediction device may determine the oil pressure control mode of the braking device as a second oil pressure control mode.

For reference, for convenience of description in the specification, the first oil pressure control mode may indicate a mode for applying oil pressure reduced by 5 bar or more from oil pressure applied to the braking device to the braking device, the second oil pressure control mode may indicate a mode for applying oil pressure reduced by 3 bar or more and 5 bar or less from the oil pressure applied to the braking device to the braking device, and the third oil pressure control mode may indicate a mode for applying oil pressure reduced by 3 bar or less from the oil pressure applied to the braking device to the braking device.

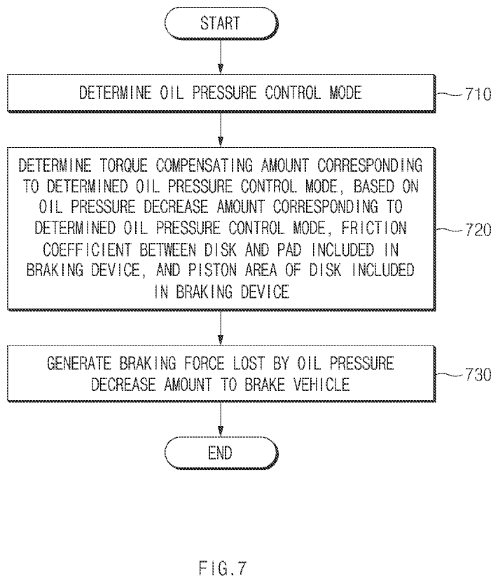

FIG. 7 is a flowchart for describing a method for braking a vehicle, in a squeal noise prediction device according to an embodiment of the present disclosure.

In operation 710, the squeal noise prediction device according to an embodiment may determine an oil pressure control mode of a vehicle. For example, as described above with reference to FIG. 6, the squeal noise prediction device may determine the oil pressure control mode, based on the result of comparing the outside air temperature with the first threshold and comparing the driving time with the second threshold, based on that the stability control mode is deactivated.

In operation 720, the squeal noise prediction device may determine a torque compensating amount corresponding to the determined oil pressure control mode, based on an oil pressure decrease amount corresponding to the determined oil pressure control mode, a friction coefficient between a disk and a pad included in a braking device, and a piston area of the disk included in the braking device. For example, when the determined oil pressure control mode is a first oil pressure control mode, the squeal noise prediction device may determine a torque compensating amount corresponding to oil pressure reduced by 5 bar or more.

In operation 730, the squeal noise prediction device may generate a braking force lost by the oil pressure decrease amount to brake the vehicle. For example, the squeal noise prediction device may apply the determined torque compensating amount to at least one of a motor for generating a braking force through regenerative braking in the vehicle, a motor for generating a braking force by use of an electronic parking brake of the vehicle, or a transmission for generating a braking force through an engine brake of the vehicle in the vehicle, or any combination thereof, thus generating a braking force lost by the oil pressure decrease amount to brake the vehicle.

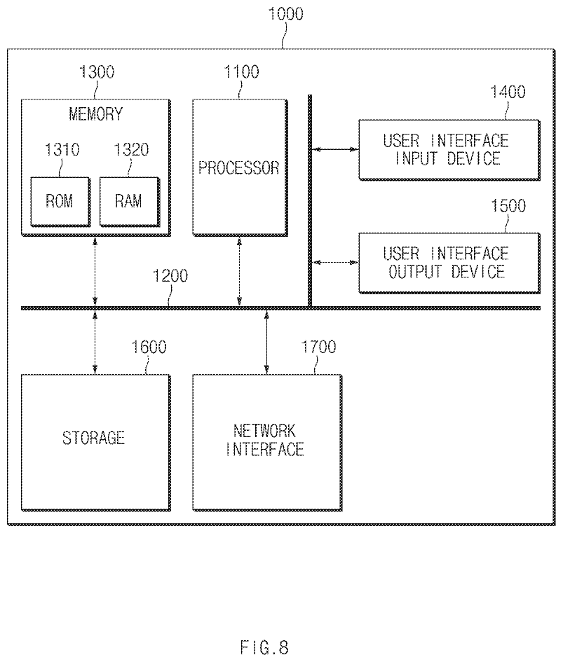

FIG. 8 is a drawing illustrating a computing system that can be associated with a learning device, a squeal noise prediction device, a learning method, and a squeal noise prediction method according to an embodiment of the present disclosure.

Referring to FIG. 8, a computing system 1000 about the learning device, the squeal noise prediction device, the learning method, and the squeal noise prediction method may include at least one processor 1100, a memory 1300, a user interface input device 1400, a user interface output device 1500, storage 1600, and a network interface 1700, which are connected with each other via a bus 1200, any combination of or all of which may be in plural or may include plural components thereof.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the example embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The example storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to example embodiments and the accompanying drawings, the present disclosure is not necessarily limited thereto, but may be variously modified and altered by those skilled in the art to which the present disclosure pertains without departing from the spirit and scope of the present disclosure claimed in the following claims.

The above-described example embodiments may be implemented with hardware components, software components, and/or a combination of hardware components and software components. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device that may execute instructions and respond. A processing unit may perform an operating system (OS) or a software application running on the OS. Further, the processing unit may access, store, manipulate, process and generate data in response to execution of software. It can be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor, together or distributed.

Software may include computer programs, codes, instructions or one or more combinations thereof and may configure a processing unit to operate in a desired manner or may independently or collectively instruct the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one computer-readable storage media.

The methods according to embodiments may be implemented in the form of program instructions that may be executed through various computer systems and may be recorded in computer-readable media. The computer-readable media may include program instructions, data files, data structures, and the like alone or in combination, and the program instructions recorded on the media may be specially designed and configured for an example or may be known and usable to those skilled in the art of computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

The above-described hardware devices may be configured to act as one or a plurality of software modules to perform the operations of the embodiments, or vice versa.

Even though the example embodiments are described with reference to restricted drawings, it may be clear to one skilled in the art that embodiments can be variously changed or modified based on the above description. For example, adequate effects may be achieved even if the foregoing processes and methods are carried out in different order than described above, and/or the aforementioned components, such as systems, structures, devices, or circuits, are combined or coupled in different forms and modes than as described above or be substituted or switched with other components or equivalents.

A description will be given below of advantages of the learning device, the squeal noise prediction device, the learning method, and the squeal noise prediction method according to an embodiment of the present disclosure.

According to at least one of embodiments of the present disclosure, the learning device may identify first noise data measured from a first external device provided in a vehicle or second noise data measured from a second external device of a user who drives the vehicle, or any combination thereof, thus reflecting a relation between a rapid change in friction coefficient between the disk and the pad and a torque estimate in the squeal noise prediction model.

Furthermore, according to at least one of embodiments of the present disclosure, the learning device may train the squeal noise prediction model based on a first loss function associated with regression or a second loss function associated with classification, thus increasing the satisfaction of the user by use of the squeal noise prediction model with better performance than training the squeal noise prediction model using one loss function.

Furthermore, according to at least one of embodiments of the present disclosure, the learning device may perform online learning of the squeal noise prediction model using the obtained data after training the squeal noise prediction model, thus reducing squeal noise capable of being generated from the braking device that is aging according to a usage condition of the user.

Other implements, other embodiments, and equivalents to claims can be within the scope of the following claims.

Therefore, the example embodiments of the present disclosure are not intended to limit the technical spirit of the present disclosure, but are provided illustrative purposes. The scope of the present disclosure can be construed on the basis of the accompanying claims, and technical ideas within the scope equivalent to the claims can be included in the scope of the present disclosure.

What is claimed is:

1. A learning device comprising:
one or more processors; and
a non-transitory storage medium storing computer-readable instructions that, when executed by the one or more processors, enable the one or more processors to:
identify one of or both of first noise data measured from a first external device provided in a vehicle and second noise data measured from a second external device of a user that drives the vehicle, and
apply training data for online learning, the training data including the one of or both of the first noise data and the second noise data, to a squeal noise prediction model trained to predict squeal noise of the vehicle to perform online learning of the squeal noise prediction model.

2. The learning device of claim 1, wherein the instructions further enable the one or more processors to:
output a request to the user for inputting whether the squeal noise is generated, at a target time point when a braking device of the vehicle operates;
identify third noise data about determination of the user, based on receiving a response about whether the squeal noise is generated from the user; and
include the third noise data in the training data for the online learning.

3. The learning device of claim 1, wherein the instructions further enable the one or more processors to:
delete parts of the training data different from the training data for the online learning and applied to training of the trained squeal noise prediction model, from the vehicle, based on the identifying of the one of or both of the first noise data or the second noise data.

4. The learning device of claim 2, wherein the instructions further enable the one or more processors to:
divide the training data for the online learning into a mini-batch being at least one group, and
apply the mini-batch to the squeal noise prediction model in a predetermined order to perform the online learning of the squeal noise prediction model.

5. The learning device of claim 4, wherein the instructions further enable the one or more processors to:
determine whether the squeal noise is generated in the braking device, based on the first noise data, the second noise data, and the third noise data; and
perform the online learning of the squeal noise prediction model, based on the mini-batch, and based on that the squeal noise is generated in the braking device.

6. The learning device of claim 5, wherein the instructions further enable the one or more processors to:
apply the mini-batch and target data corresponding to the mini-batch to the squeal noise prediction model to obtain temporary output data; and
perform the online learning of the squeal noise prediction model, based on a first loss value obtained by applying the temporary output data and the target data to a first loss function associated with regression.

7. The learning device of claim 6, wherein the instructions further enable the one or more processors to perform the online learning of the squeal noise prediction model, based on a second loss value obtained by applying the temporary output data and the target data to a second loss function associated with classification.

8. The learning device of claim 1, wherein the first external device includes a hands-free microphone of the vehicle, and
wherein the second external device includes a portable device microphone of a portable device of the user.

9. A squeal noise prediction device, comprising:
one or more processors; and
a non-transitory storage medium storing computer-readable instructions that, when executed by the one or more processors, enable the one or more processors to:
apply at least one of or any combination of braking data extracted from a braking device of a vehicle, wheel data corresponding to a wheel of the vehicle, external data measured from an external sensor of the vehicle, hands-free microphone data measured from a hands-free microphone of the vehicle, and portable device data measured from a portable device of a user of the vehicle, to a squeal noise prediction model to obtain an expected probability indicating a probability that squeal noise will be generated in the braking device,
determine that the squeal noise is generated in the braking device, based on that the expected probability is greater than a predetermined threshold, and
determine an oil pressure control mode of the vehicle, based on at least one of or any combination of a stability control mode of the vehicle, an outside air temperature measured from the external sensor, and a driving time of the vehicle, and based on that the squeal noise is generated in the braking device.

10. The squeal noise prediction device of claim 9, wherein the instructions further enable the one or more processors to:
determine a torque compensating amount corresponding to the determined oil pressure control mode, based on an oil pressure decrease amount corresponding to the determined oil pressure control mode, a friction coefficient between a disk and a pad included in the braking device, and a piston area of the disk included in the braking device; and
apply the torque compensating amount to at least one of or any combination of a regenerative braking motor for generating a regenerative braking force through regenerative braking in the vehicle, an electronic parking brake motor for generating an electronic parking braking force by an electronic parking brake of the vehicle, or a transmission for generating a transmission braking force by an engine brake in the vehicle, to generate a compensating braking force lost by the oil pressure decrease amount to brake the vehicle.

11. A learning method, comprising:
identifying at least one of or both of first noise data measured from a first external device provided in a vehicle and second noise data measured from a second external device of a user that drives the vehicle; and
applying training data for online learning, the training data including the at least one of or both of the first noise data and the second noise data, to a squeal noise prediction model trained to predict squeal noise of the vehicle to perform online learning of the squeal noise prediction model.

12. The learning method of claim 11, wherein the performing of the online learning of the squeal noise prediction model includes:
outputting a request to the user for inputting whether the squeal noise is generated at a target time point when a braking device of the vehicle operates;
identifying third noise data about whether the squeal noise is generated at the target time point according to a response of the user; and
including the third noise data in the training data for the online learning.

13. The learning method of claim 11, wherein the performing of the online learning of the squeal noise prediction model includes:
deleting parts of the training data different from the training data for the online learning and applied to training of the trained squeal noise prediction model, from the vehicle, based on the identifying of the at least one of or both of the first noise data and the second noise data.

14. The learning method of claim 12, wherein the performing of the online learning of the squeal noise prediction model includes:
dividing the training data for the online learning into a mini-batch being at least one group; and
applying the mini-batch to the squeal noise prediction model in a predetermined order to perform the online learning of the squeal noise prediction model.

15. The learning method of claim 14, wherein the performing of the online learning of the squeal noise prediction model includes:
determining whether the squeal noise is generated in the braking device, based on the first noise data, the second noise data, and the third noise data; and
performing the online learning of the squeal noise prediction model, based on the mini-batch, and based on that the squeal noise is generated in the braking device.

16. The learning method of claim 15, wherein the performing of the online learning of the squeal noise prediction model includes:
applying the mini-batch and target data corresponding to the mini-batch to the squeal noise prediction model to obtain temporary output data; and
performing the online learning of the squeal noise prediction model, based on a first loss value obtained by applying the temporary output data and the target data to a first loss function associated with regression.

17. The learning method of claim 16, further comprising performing the online learning of the squeal noise prediction model, based on a second loss value obtained by applying the temporary output data and the target data to a second loss function associated with classification.

18. The learning method of claim 11, wherein the first external device includes a hands-free microphone of the vehicle, and
wherein the second external device includes a portable device microphone of a portable device of the user.

19. A squeal noise prediction method, comprising:
applying at least one of or any combination of braking data extracted from a braking device of a vehicle, wheel data corresponding to a wheel of the vehicle, external data measured from an external sensor of the vehicle, hands-free microphone data measured from a hands-free microphone of the vehicle, and portable device data measured from a portable device of a user of the vehicle, to a squeal noise prediction model to obtain an expected probability indicating a probability that squeal noise will be generated in the braking device;
determining that the squeal noise is generated in the braking device, based on that the expected probability is greater than a predetermined threshold; and
determining an oil pressure control mode of the vehicle, based on at least one of or any combination of a stability control mode of the vehicle, an outside air temperature measured from the external sensor, and a driving time of the vehicle, and based on that the squeal noise is generated in the braking device.

20. The squeal noise prediction method of claim 19, further comprising:
determining a torque compensating amount corresponding to the determined oil pressure control mode, based on an oil pressure decrease amount corresponding to the determined oil pressure control mode, a friction coefficient between a disk and a pad included in the braking device, and a piston area of the disk included in the braking device; and
applying the torque compensating amount to at least one of or any combination of a regenerative braking motor for generating a regenerative braking force through regenerative braking in the vehicle, an electronic parking brake motor for generating an electronic parking braking force by an electronic parking brake of the vehicle, or a transmission for generating a transmission braking force by an engine brake of the vehicle, to generate a compensating braking force lost by the oil pressure decrease amount to brake the vehicle.
